(19) United States
(12) Patent Application Publication
(10) Pub. No.: US 2001/0044765 A1
(43) Pub. Date: Nov. 22, 2001

(54) Method for funding post-secondary education

(76) Inventor: Steven Wolberg, Newton, MA (US)

Correspondence Address: MORSE ALTMAN & MARTIN, P.O. BOX 6926, BOSTON, MA, 02106, US

(21) Appl. No.: 09/877,364

(22) Filed: Jun. 8, 2001

(51) Int. Cl. G06F 17/60

(52) U.S. Cl. 705/35

(57) ABSTRACT

A method for financing post-secondary education undertaken at a future date by at least some members of a predetermined group, the method comprising (a) determining a future average cost of post-secondary education at the future date; (b) determining basic plan payments for members of the group based, in part, on the future average cost, a projected percentage of the group that will become plan members, a projected percentage of plan members that will attend college, and a projected percentage of students that will withdraw from college prior to completion; (c) enrolling members of the group into the program; (d) receiving plan payments from plan members; and (e) disbursing payments for each student while she is in college.

### CROSS-REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to methods for funding an individual's education, more specifically, to methods that will provide funds to pay for a person's post-secondary education at the time in the future when that person attends an educational institution of his or her choice.

2. Description of the Related Art

Numerous studies have demonstrated the importance of a college education. A college degree is largely viewed as the entry point for a better career and better life. This is truer in today's age than it was in previous generations. A college degree is no longer the goal and aspiration of the wealthier segments of society; it is viewed as a necessary requirement for all. It has been shown that those individuals that receive a post-secondary education have significantly greater median earnings than those individuals that only completed high school.

Within the context of the United States of America, research has shown that Americans understand the importance of college education, but the majority also feel that cost of such an education is becoming increasingly unaffordable. Enrollment in post-secondary education has been rising for all economic, racial, and ethnic groups. Yet an individual's chances of entering and completing college remain closely correlated to socioeconomic status and family background. Wide gaps in opportunity persist between those at the bottom of the economic ladder and those at the top, and among White, Black, Asian, and Hispanic Americans.

A variety of mechanisms have been developed as a response to the high cost of post-secondary education.

(1) Savings Programs. There are numerous types of savings instruments and investment vehicles that are designed to assist investors (typically parents) to prepare for the future costs of providing beneficiaries (typically the investor's children) with a post-secondary education. These programs include saving's accounts, Certificates of Deposit (“CDs”), money market accounts, stocks, bonds, mutual funds, treasury securities, educational IRAs, and state college savings plans (commonly known as “529 plans”). Each of these savings instruments varies in risk, return, liquidity, tax deferred status, and time frame.

None of the aforementioned savings/investment vehicles guarantee that the amount of money saved and/or invested will cover the cost of education at all post-secondary institutions. Thus, there are no “guaranteed full payment” benefits associated with these programs.

An example of such a mechanism is disclosed in U.S. Pat. Nos. 4,642,768 and 4,722,055, both issued to Roberts. Roberts discloses a method for receiving insurance premiums determined by the expected cost of college and managing the accumulated premiums in an attempt to grow the fund to the expected cost. There is no guarantee that the value of the fund at maturity will cover the actual cost of the college selected.

(2) Financial Aid Programs. There are also various financial aid sources that attempt to defray the cost of a post-secondary education. Commonly, financial aid sources are in the form of grants/scholarships, loans, or work-study programs. The majority of financial aid awarded is in the form of loans. The most common government sponsored loan programs include the Stafford Loan Program, Perkins Loan Program, Supplemental Loans for Students, and Parent Loans for Undergraduate Students. There are also a variety of private loan sources and post-secondary school sponsored loan programs. Despite the existence of financial aid plans, the implementation and administration of these programs suffer from a number of disadvantages, for example:

a) Applying for financial aid may be detrimental to an applicant's acceptance at non-“need-blind” post-secondary institutions. Financial aid applicants may be rejected at certain post-secondary institutions solely because of their need for financial assistance.

b) After graduation from a post-secondary institution, a significant number of financial aid recipients are confronted with the hardship of substantial loan repayments. Loan repayment schedules generally do not take into consideration the income of the financial aid recipient. Accordingly, the amount a financial aid recipient repays each month is generally a fixed amount, regardless of her financial situation. Thus, the lower the financial aid recipient's income, the more likely it is that she will be unable to meet the loan repayment obligations.

c) Low-interest funds for financing a college education may have limited availability. For example, it may not be possible to obtain a low-interest student loan to cover the full cost of an education. In particular, there are very few programs that will provide a single loan to cover the educational expenses for a full year, much less for complete four-year degree.

d) Due to the limited supply of financial aid resources there is no guarantee that the monetary amount awarded to a student applicant will cover the cost of education at any and all post-secondary institutions. Simply stated, there is no “guaranteed full payment” benefits associated with these financial aid programs.

(3) Insurance Programs. Insurance programs protect against an uncertain future event; they are primarily designed to fund a liability having a reasonably predetermined value. For example, the need to replace a car or a home in case of its loss or the need to provide a fixed amount in case of disability or death. Insurance plans typically do not insure for a future event where the payout value is uncertain. There are no insurance programs that guarantee the full payment of tuition and/or other associated costs of obtaining a post secondary education at any institution of the beneficiary's choice.

### BRIEF SUMMARY OF THE INVENTION

An object of the present invention is to make higher education more affordable by providing a method that guarantees the payment of the costs of tuition and/or other costs associated with post-secondary education at an educational institution of the plan member's choice.

Another object is to provide a post-secondary education funding plan in which the availability of funds are less limited and the likelihood of student loan repayment default is greatly reduced or eliminated.

A further object is to provide a post-secondary education funding method that eliminates the financial bias at need-aware post-secondary institutions.

In the method of the present invention, a plan member makes predetermined payments to a program provider, such as a financial institution, over a period of time in exchange for the program provider paying the cost of a post-secondary education at a future date at an institution of the plan member's choice.

The method of the present invention is a method for financing at least a portion of post-secondary education undertaken at a future date by at least some members of a predetermined group. The method comprises (a) determining a future average cost of post-secondary education at the future date based, in part, on current average cost of post-secondary education, historic rate of change of cost of post-secondary education, projected rate of change of cost of post-secondary education, and the amount of time from the present until said future date; (b) determining basic plan payments for members of the group based, in part, on the future average cost, a projected percentage of the group that will enroll in the program as plan members, a projected percentage of plan members that will undertake the post-secondary education as students, and a projected percentage of students that will withdraw from post-secondary education prior to completion; (c) enrolling members of the group into the program as plan members; (d) receiving plan payments from plan members; and (e) disbursing payments for each student while she is undertaking post-secondary education.

The method of the present invention provides for the relative certainty of pursuing a college education at a future time with the uncertainty of the costs required at that time. The costs are uncertain because the particular college that the plan member will attend and the costs of that college are unknown. Play payments are determined using a number of criteria, including present college costs, expected college costs, birth rates, mortality rates, age of college attendance, college acceptance and dropout rates, etc. Plan payment calculations begin with college costs for the current year. The costs for the first year of college is determined, in part, from the current costs, the rate of change of college costs, the likelihood that a person will attend college, and the number of years until college. Each additional year then factors in college withdrawal rates and asset investment returns. The costs for all the years of college are summed and a standard present value calculation is performed to determine the amount of money that must be invested. This amount is adjusted to include taxes and profit for the program provider. The resulting total is divided by contract into a payment schedule.

Plan payments from all plan members are invested as a whole to increase program assets. The manner of asset management is an aspect of the present invention. The program enroll members continuously. When the first plan members to reach college age and begin attending college, the program provider will begin making disbursements as contracted. It is expected that the program will continue indefinitely, continuously enrolling members and, once the initial period of years has expired, to continuously disburse monies to the plan members or institutions as they reach college age and begin attending college.

It is contemplated that the plan may cover all or part of the student's expenses. It is further contemplated that additional benefits may be purchased, such as protection against the death or disability of the paying party.

Eligibility or disbursement criteria may be incorporated into the plan, for example, what colleges may be attended, the number of years of college that will be paid, and the maximum age at plan enrollment

Other objects of the present invention will become apparent in light of the following drawings and detailed description of the invention.

### BRIEF DESCRIPTION OF THE DRAWINGS

For a fuller understanding of the nature and object of the present invention, reference is made to the accompanying drawings, wherein:

FIG. 1 is a block diagram showing an example of plan payment calculations.

### DETAILED DESCRIPTION OF THE INVENTION

The method described herein contemplates that a provider, such as a financial institution, implement a program whereby predetermined payments are made over a period of time in exchange for the program provider paying the uncertain cost of a post-secondary education at a future date at an institution of the plan member's choice. It is expected, though not required, that the plan member will be the potential student, since the plan payments are tied to the age of the potential student, as described below. The identity of the party actually making the plan payments, whether it be the plan member's parent, guardian, the plan member herself, or other interested party, is not important.

Typically, insurance policies protect against an uncertain future event. They are designed to fund a liability of a certain value and are structured to protect against relatively large liabilities with a relatively small probability of occurrence, for example, personal injury liability.

The method of the present invention differs from insurance policies in that it provides for a relatively certain future activity, namely, undertaking a post-secondary education, with an uncertain disbursement value. The uncertainty derives from the fact that the plan member does not know which post-secondary institution she will attend, what the cost of that particular institution will be relative to other institutions, and generally what increases can be expected in post-secondary education costs from the date of the inception of the plan to the date that the plan member attends college. In determining the amount of the plan payment, the program provider may include, but is not limited to, the following variables: present cost of college, predicted future cost of college, types of colleges, matriculation by type of college, child birth rates, child mortality rate, child disability rates, probability of attending college, college acceptance rates, age for college attendance, age of plan member at plan enrollment, duration of a college education, likelihood of inability to continue plan payments, transferability and assignability, and college dropout rates.

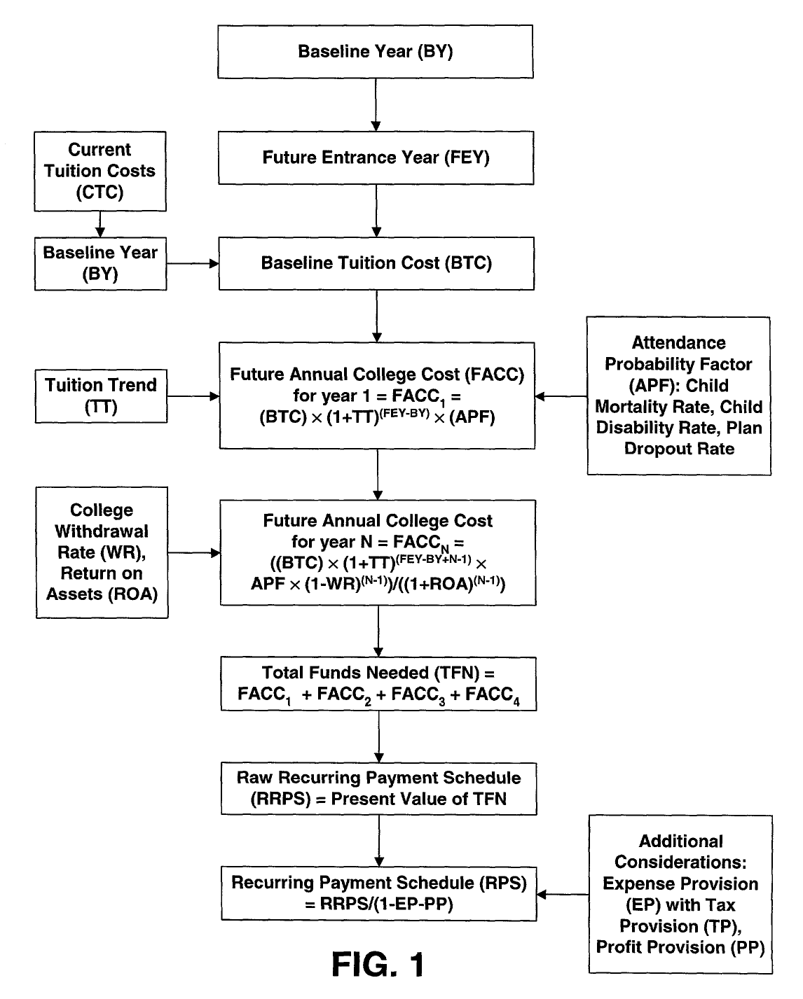

An example for calculating basic plan payments is shown in FIG. 1. FIG. 1 depicts a flow chart for the calculation of the recurring payment schedule (RPS), i.e., the plan payments. The calculation of the RPS is primarily dependent on present and projected college costs, the projected number of years until college entrance, the probability of payout, and expense and profit provisions.

The calculation begins with the baseline year (BY) or current year. Data providing the average age of undertaking a college education is then used to calculate the future entrance year (FEY). Next, the baseline tuition cost (BTC) is determined using current tuition cost data weighted by the probability of students matriculating in institutions as a function of cost. Different institutions have different costs associated with them and different numbers of students in attendance. These two values make up a current cost distribution for attending college. At the low end of the distribution are institutions, particularly state-run colleges, that have relatively low costs. At the high end of the distribution are relatively expensive institutions, such as private universities. The BTC is the mean of the current cost distribution.

Data concerning the rate of change of college costs, or the tuition trend (TT), and the likelihood that a person will undertake a college education, or the attendance probability factor (APF), are used to determine the future annual college cost (FACC). The TT is determined by predicting how college costs will change, typically relying, in part, on the past history of how college costs have changed. APF is an amalgamation of several variables, which may include, but is not limited to, child mortality rates, child disability rates, and program dropout rates. Program dropout rates come from a number of factors, including the inability of enrolled members to continue plan payments, the likelihood of the plan member being accepted to a college, and likelihood that the plan member will not want to attend college.

The FACC for the first year of college, FACC₁=(BTC)×(1+TT)^{(FEY-BY)}×(APF). Each additional year N of future college costs also accounts for the percentage of students that withdraw from college per year (WR) and the return on assets (ROA), or investment income, necessary to fund each additional year. Thus, FACC_{N}=((BTC)×(1+TT)^{(FEY-BY+N-1)}×APF×(1−WR)^{(N-1)})/((1+ROA)^{(N-1)}). It is anticipated that the number of academic years that the program will provide a disbursement will be limited. In this example, the disbursement is limited to four consecutive academic years, and the sum of disbursements for four years is the total funds needed TFN=FACC₁+FACC₂+FACC₃+FACC₄. A standard present value calculation of the TFN, which calculates the amount of money that must be invested at a given interest rate over a specified time period, provides the raw recurring payment schedule (RRPS). Finally an expense provision (EP), which includes a tax provision (TP), and a profit provision (PP) required by the program provider are incorporated into the RRPS to yield the RPS, where RPS=RRPS/(1-EP-PP). The plan member would be required to pay the RPS according to a contracted-for schedule in order to receive the program benefits.

The following example depicts the calculation of the RPS, and the numbers used herein are for illustrative purposes only. The BY is 2001 and the plan member is enrolled at birth. Assuming the average age at which a person starts college is 19, the FEY is 2020. In this example, the BTC in year 2001 is assumed to be $8,560, the TT is a 7% annual increase, and the APF is 80%. The projected cost of the first year of college, FACC₁, yields a value of $24,766. Assuming a WR of 5% per year and a ROA of 7% per year, and assuming that the program will only pay for four consecutive academic years, the projected costs for years 2, 3, and 4 are FACC₂−$23,528, FACC₃=$22,351, and FACC₄=$21,234. Note that the amount for each year is actually less than that of the preceding year. In this example, the FACC_{N} decreases in each successive year because the ROA and the TT are both 7%, essentially canceling each other out, while the WR reduces each subsequent FACC_{N} by approximately 5%.

Adding the four FACC_{N} values, the TFN=$91,879. To arrive at the RRPS, the present value of $91,879 is calculated. The present value is the current, or BY dollar, value of the TFN, or the amount of money that would need to be invested to yield the TFN. In this example, the TFN is structured as an annuity, a pattern of periodic, constant payments at a constant interest rate of 0.6% per month. The RRPS, assuming monthly plan payments until the FEY, is approximately $181 per month. Adjusting for an EP and PP of 7% and 5%, respectively, yields an RPS monthly payment of approximately $206.

The plan payments may be fixed over the term of the plan, vary based on an inflation-tied multiplier, vary based on one or more other variables including those listed above, or any combination thereof. Plan payments may be made monthly, bimonthly, quarterly, annually, semi-annually, or on any other schedule deemed appropriate. It is further contemplated that an initial or nonrecurring lump-sum payment may be required to enroll in the plan.

The present invention contemplates that plan payments from all plan members will be collected by the program provider and invested in a manner that will increase the assets of the program. The plan payments collected are not kept in separate funds accounts by plan member and there is no individual accounting for each member, other than to keep track of each member's plan payments to ensure payments are being made. The manner in which the program assets are managed is not an aspect of the present invention, and it is contemplated that the program provider may employ any management techniques that it deems appropriate. The program will continue to enroll members, whose plan payments are added to the assets of the program. At some point after the initial period of years that it takes for the first plan members to reach college age, plan members will begin attending college, and the program provider will begin making disbursements to the plan members or educational institutions, depending on the requirements of the particular program. It is expected that the program will continue indefinitely, continuously enrolling members and, once the initial period of years has expired, to continuously disburse monies to the plan members or institutions as they reach college age and begin attending college.

The price an institution charges for tuition and fees, as well as room and board for those students residing on campus, is the institution's published price. A complete student expense budget also includes books, supplies, and transportation. A plan written under a program of the present invention may cover all or part of the student's expenses of attending a post-secondary institution. For example, a basic plan may only cover published tuition and fees. The basic plan would be particularly attractive if it is contemplated that the room and board costs would be minimal. In this example, it is also contemplated that addenda to the plan may be purchased to cover room, board, transportation, supplies, and/or material fees.

It is further contemplated that additional benefits may be purchased from the program provider. Additional plan payments may be paid to cover, for example, protection against the untimely death of the paying party and/or protection against the paying party being unable to continue plan payments (e.g. because of disability or loss of employment).

It is contemplated that eligibility or disbursement criteria may be incorporated into the plan. The following examples are merely illustrative, and it is contemplated that contractual terms regulating the program, other than those described, below may apply.

(1) The post-secondary institutions that can be attended may be limited to accredited institutions located in the United States.

(2) The number of academic years of college that will be paid by the program provider may be limited to a predetermined number that must be attended during a predetermined number of calendar years. For example, disbursements are limited to four academic years over a period not to exceed five calendar years from the date of first matriculation.

(3) Enrollment in the program can be limited to members who are under a predetermined age based on the average age of attending college, for example, eight years of age. The purpose is to keep plan payments relatively low. The older the plan member is when starting the program, the fewer years there will be for making plan payments, and the greater the payments would need to be to participate.

Alternatively, the program could be set up to require a certain minimum number of years of participation in the plan before disbursements are made. Using the above maximum age for enrolling of eight years and the average age for starting collage of 19 years old, a member enrolling at eight years of age will be paying into the plan for eleven years. The alternative program can be set up so that a plan member must pay into the program for at least eleven years prior to attending college. For example, if the member enrolled at age 10, she would not be eligible for disbursements until age 21.

(4) At least a portion of plan payments received can be returned to those plan members who, for example, (a) do not attend college for any reason, e.g., death, non-acceptance, etc., (b) stop making plan payments for any reason, e.g., death, inability to pay, etc., or (c) receive a grant or scholarship that at least partially funds their education.

The post-secondary funding method of the present invention provides the following benefits:

(1) It provides all individuals the same financial opportunity to attend the post-secondary educational institution of their choice, including those for who post-secondary education may not otherwise have been financially possible.

(2) It represents a “forced savings” vehicle for parents to save for their child's college education.

(3) It provides a key motivator to students to perform well during their high school years since their tuition costs at the post-secondary institution of their choice will already be paid.

(4) It removes affordability as a criterion in the college selection process.

(5) It has long-term macro-economic benefits. Plan members will graduate from college without tuition debt and will have more disposable income for spending on nonessentials and/or for purchasing a house earlier than would otherwise be possible.

The method disclosed in U.S. Pat. No. 4,642,768, issued to Roberts, has what appear to be superficial similarities to the present invention. However, there are several significant differences. The method of Roberts is foremost a means for managing the account of one person. As can be seen in FIG. 1, Roberts discloses a method for managing a fund, including steps of receiving payments, recording transactions, keeping track of assets, reporting fund status and tax liability. Amounts that need to be periodically invested in order to reach the desired level of funding are periodically calculated throughout the life of the fund.

In contrast, the method of the present invention is essentially a method for guaranteeing the cost of college at some time in the future, by using actuarial statistics to determine, at the beginning of the plan, what payments are necessary to participate. Payments for the entire term of the plan are typically known up front; they will not typically change depending on the present state of the economy. Also, the present invention is not a method for managing received payments to maximize value at the end of the plan term. Granted, the program provider will most likely try to invest the payments to maximize value, but to the plan member, this is not an issue. The plan member only cares that her future college education costs will be paid by the program provider.

Secondly, Roberts discloses a method for managing the fund of a single person, based on what that one person and that one person alone contributes. As indicated above, the present invention uses actuarial statistics of a large demographic group that include many factors for determining plan payments. All of the plan payments to a single program provider are intermingled; there is no accounting or separation of the payments of a single person. How the program provider manages the plan payments to achieve the goal of having enough funds to pay college costs for all of the plan members is not an aspect of the present invention.

Thus it has been shown and described a method for funding post-secondary education which satisfies the objects set forth above.

Since certain changes may be made in the present disclosure without departing from the scope of the present invention, it is intended that all matter described in the foregoing specification and shown in the accompanying drawings be interpreted as illustrative and not in a limiting sense.

1. A method for financing at least a portion of post-secondary education undertaken at a future date by at least some members of a predetermined group, said method comprising the steps of:
(a) determining a future average cost of post-secondary education at said future date, said determination based, in part, on current average cost of said post-secondary education, historic rate of change of cost of post-secondary education, projected rate of change of cost of post-secondary education, and the amount of time from said determining of said future average cost until said future date;
(b) determining basic plan payments for members of said group based, in part, on said future average cost, a projected percentage of said group that will enroll in said program as plan members, a projected percentage of said plan members that will undertake said post-secondary education as students, and a projected percentage of said students that will withdraw from said post-secondary education prior to completion;
(c) enrolling members of said group into said program as said plan members;
(d) receiving said plan payments from said plan members; and
(e) disbursing payments for each of said students while said each of said students is undertaking said post-secondary education.

2. The method of claim 1 wherein said payments are disbursed for a predetermined number of academic years during a predetermined number of calendar years.

3. The method of claim 1 wherein said members are limited to enrolling in said plan a predetermined minimum number of years prior to said future date.

4. The method of claim 1 wherein said future date is determined using the average age of matriculation in a post-secondary institution.

5. The method of claim 1 wherein said plan payments are adjusted for the age of said plan member at the time of enrollment.

6. The method of claim 1 wherein membership in said predetermined group is limited by predetermined criteria.
